(19) United States
(12) Patent Application Publication
(10) Pub. No.: US 2012/0025653 A1
(43) Pub. Date: Feb. 2, 2012

(54) AGGREGATE MAGNETIZATION SKEW IN A PERMANENT MAGNET ASSEMBLY

(76) Inventor: Rafael Octavio Maynez, Anderson, SC (US)

(21) Appl. No.: 12/846,173

(22) Filed: Jul. 29, 2010

(51) Int. Cl. H02K 1/17; H02K 15/03

(52) U.S. Cl. 310/154.28; 29/596

(57) ABSTRACT

A permanent magnet for use in an electro-dynamic machine. The permanent magnet has a longitudinal axis and a plurality of ferromagnetic ring members arranged in a co-axial stack. Each ring member has a plurality of arcuate magnetic poles arranged around a circumference of the ring members. The ring members are magnetized such that a pole boundary between each pair of magnetic poles is skewed at an angle Φ, where Φ is non-parallel to the longitudinal axis.

### BACKGROUND

The present invention relates to electric motors. More particularly, the invention relates to reducing cogging torque in electric motors. Cogging torque is caused by the magnetic attraction between permanent magnet edges and lamination poles in a motor. Cogging torque is the amount of torque required to move the rotor out of those positions. The net effect of this magnetic attraction is that the rotor of an electric motor does not turn freely. The condition is undesirable because it lowers efficiency and produces torque ripple during motor operation.

One method of reducing cogging torque is to design a motor such that magnet edges and lamination poles are not parallel and, therefore, cannot align. This arrangement is known as magnetization “skew.” An ideal skew angle for magnetization is one rotor pole pitch. That is, the skew starts at the front of the motor, at the tip of one pole, and ends at the rear of the motor, at the tip of the next pole. This configuration allows for the smoothest possible transition across attracting features.

The disadvantage of magnetization skew in electric motors is that the effective field of the magnet is reduced. Increasing the skew angle comes at the expense of reducing that portion of the magnet which performs useful work. The material of the magnet within a skew area does not fully contribute to the performance of the motor. More specifically, if a coil completes commutation before exiting the transition zone, the coil is exposed to magnets of both polarities. In this condition, opposing forces are generated which cancel each other out. The net effect is that magnetic material is effectively wasted. Thus, where magnetization skew is used to minimize cogging torque, there exists an inherent tension between minimizing cogging torque and maximizing magnet utilization.

### SUMMARY

In one embodiment, the invention provides a permanent magnet assembly for use in an electro-dynamic machine. The permanent magnet assembly has a plurality of ferromagnetic ring members arranged about a longitudinal axis in a co-axial stack. Each ring member has an axial orientation. A plurality of arcuate magnetic poles are arranged around a circumference of the ring member. Pole boundaries between magnetic poles are skewed at an angle Φ that is non-parallel to the longitudinal axis.

In another embodiment, the invention provides a method of manufacturing a permanent-magnet portion of an electro-dynamic machine. The method includes manufacturing a plurality of ferromagnetic ring members. Each ring member has a central axis, a radius and an axial height. Each ferromagnetic ring member is magnetized to have a plurality of arcuate magnetic poles arranged around a circumference of the ring member. The arcuate magnetic poles within each ring member contact one another at axially-skewed boundaries. The ferromagnetic rings are arranged in a co-axial stack.

In yet another embodiment, the invention provides an electric motor. The electric motor includes a shaft rotatable about an axis, a rotor coupled to the shaft for rotation about the axis, and a stator disposed concentrically about the rotor to provide a magnetic field. The stator includes a first ferromagnetic ring having at least a first magnetic pole and a second magnetic pole adjacent the first magnetic pole. A boundary between the first magnetic pole and the second magnetic pole defines a first skew angle. A second ferromagnetic ring has at least a third magnetic pole and a fourth magnetic pole adjacent the third magnetic pole. A boundary between the third magnetic pole and the fourth magnetic pole defines a second skew angle. The second ferromagnetic ring is stacked axially upon the first ferromagnetic ring.

In still yet another embodiment, the invention provides a permanent magnet assembly for use in an electro-dynamic machine. The permanent magnet assembly has a plurality of ferrimagnetic ring members arranged about a longitudinal axis in a co-axial stack. Each ring member has an axial orientation. A plurality of arcuate magnetic poles are arranged around a circumference of the ring member. Pole boundaries between adjacent magnetic poles are skewed at an angle Φ, where Φ is non-parallel to the longitudinal axis.

Other aspects of the invention will become apparent by consideration of the detailed description and accompanying drawings.

### BRIEF DESCRIPTION OF THE DRAWINGS

FIG. 1 is a perspective view of an electric motor according to one aspect of the invention.

FIG. 2 is a top view of a stator of the electric motor of FIG. 1.

FIG. 3 is a perspective view of a ring magnet with an aggregate magnetization skew according to one aspect of the invention.

FIG. 4 is a cross-sectional view of the stator of FIG. 2 along line 4-4.

FIG. 5 is a perspective view of a method of constructing a permanent-magnet assembly according to one aspect of the invention.

FIG. 6 is a perspective view of a method of constructing a permanent-magnet assembly according to another aspect of the invention.

FIG. 7 is a perspective view comparing design magnetization patterns of the permanent magnet assemblies of FIGS. 5 and 6 with their actual magnetization patterns.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

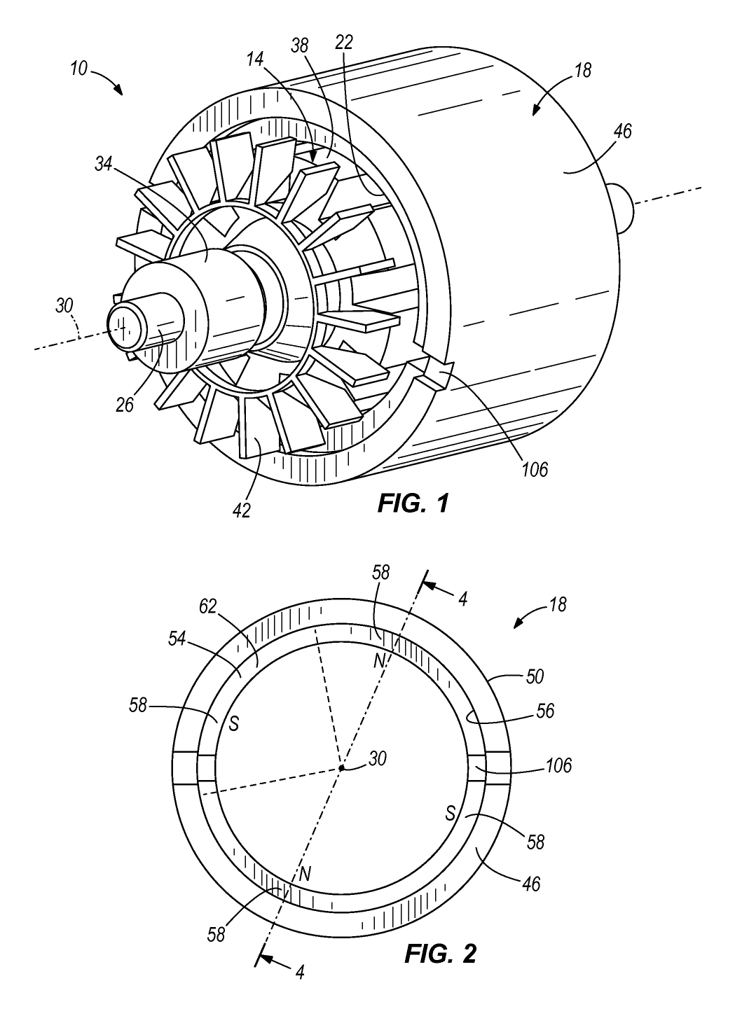

FIG. 1 is a perspective view of an electro-dynamic machine, such as a motor 10. The motor 10 has a rotor 14 and a stator 18. A radial air gap 22 separates the stator 18 from the rotor 14. The rotor 14 is coupled to a shaft 26 for rotation about an axis 30. A magnetic field of the stator 18 interacts with a magnetic field of the rotor 14 to produce a useful torque about the axis 30.

The illustrated motor 10 is a brushed direct-current (DC) motor, such as for use with power tools, though the invention is applicable to other types of motors and motor uses. It should also be appreciated that the invention is also applicable to generators.

The motor 10 generates an oscillating current in the rotor 14, or armature, with a commutator 34. The rotor 14 includes one or more coils of wire (not shown) wound around a metallic core 38 on the shaft 26. An electrical power source is connected to the rotor coil through the commutator 34 and commutator brushes (not shown), causing current to flow in the coils, producing electromagnetism. The commutator 34 causes a current in the coils to be switched as the rotor 14 turns, keeping the magnetic poles of the rotor 14 from ever fully aligning with the magnetic poles of the stator 18, such that the rotor 14 never stops but rather keeps rotating indefinitely. In the illustrated construction, a fan 42 is coupled to the rotor 14 to provide cooling during operation.

Although the embodiments of the invention are described below in the context of a permanent-magnet stator, it should be appreciated that the principles of the invention are equally applicable to permanent-magnet rotor construction.

FIG. 2 is a top view of the stator 18 shown in FIG. 1. A metallic flux ring 46 forms an outer radial surface 50 of the stator 18 about axis 30. A permanent magnet assembly 54 is disposed adjacent an inner radial surface 56 of the flux ring 46 about axis 30. In the illustrated embodiment, the permanent magnet assembly 54 has four magnetic poles (N, S, N, S) 58 arranged circumferentially about axis 30. Each pole 58 forms an arcuate segment 62 of the permanent magnet assembly 54. In other constructions, a stator with a different number of poles may be used. For example, 2, 6, 8 or other numbers of poles may be used.

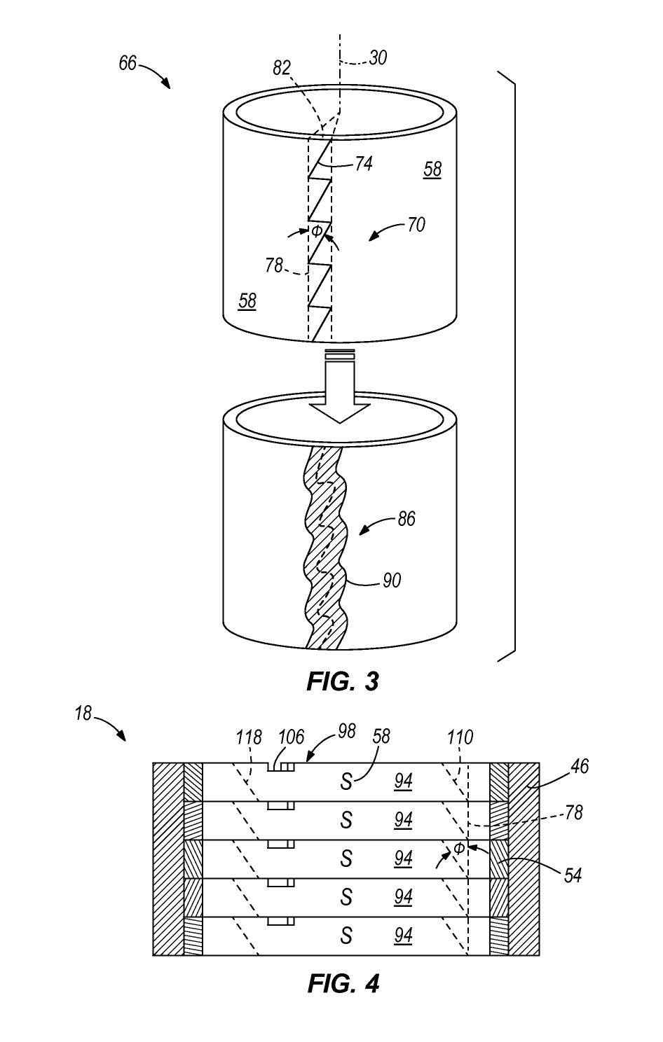

FIG. 3 is a perspective view of a ferromagnetic ring 66. FIG. 3 illustrates an exemplary way to maximize an effective magnetization skew (and thereby minimize cogging torque), while simultaneously maximizing magnet utilization for producing useful torque. The ferromagnetic ring 66 is magnetized such that a design skew pattern 70 is formed at the boundary between magnetic poles 58. The design skew pattern 70, illustrated in the upper half of FIG. 3, is formed as an aggregate of several linear segments, 74, and can thus be described as an “aggregate” magnetization skew 70.

A skew angle Φ for linear segment 74 can be defined relative to a reference line 78. The reference line 78 is parallel to the orientation of the axis 30, though the skew angle Φ could be defined relative to another reference. Each of the linear segments 74 provides a large effective skew angle Φ that minimizes cogging torque. Simultaneously, the design aggregate magnetization skew 70 is confined to a relatively narrow annular segment 82 of the ferromagnetic ring 66, thereby maximizing the area of the permanent magnet available to produce useful torque. The skew angle Φ will typically be in the range from approximately 15 degrees to approximately 75 degrees; preferably from approximately 30 degrees to approximately 60 degrees, and even more preferably from approximately 40 degrees to approximately 50 degrees. For a commutated DC machine, such as that illustrated in FIG. 1, the design may be optimized by confining the design aggregate magnetization skew 70 within an area of the magnet that does not interact with the armature due to commutation. This “inactive” magnet area is a function of commutator and brush geometry for a given motor configuration, and can be determined by well-known methods.

A design aggregate magnetization skew 70 such as illustrated in FIG. 3 is not easily manufacturable within a ring magnet using existing techniques. Shaping magnetic poles in a magnetization fixture to form the design magnetization pattern may be impractical since magnetic field lines follow the path of least resistance. The lower half of FIG. 3 illustrates the actual magnetization pattern 86 resulting from the design aggregate magnetization skew 70 pattern illustrated in the upper half of FIG. 3. As illustrated, magnetization boundaries 90 formed in this manner tend to be thick, fuzzy lines. This is a result of the well-known tendency of magnetic field lines to bypass abrupt corners and to diffuse sharp edges (i.e., to follow the path of least resistance). The design aggregate magnetization skew 70 is diminished as the rounded, blurred magnetization boundaries 90 significantly reduce the capacity of the skew to minimize cogging torque.

As an alternative to magnetizing a single ferromagnetic ring 66, an aggregate magnetization skew 70 may be formed using an axial stack of ferromagnetic rings, where each ring is individually magnetized with a straight magnetization skew. An assembly of multiple ferromagnetic rings allows the use of standard manufacturing methods to generate complex skew patterns. Assembly of the ring magnets requires little deviation from typical processes. The rings slip over or inside other rotor or stator components and are secured with existing techniques, such as an epoxy-resin potting compound.

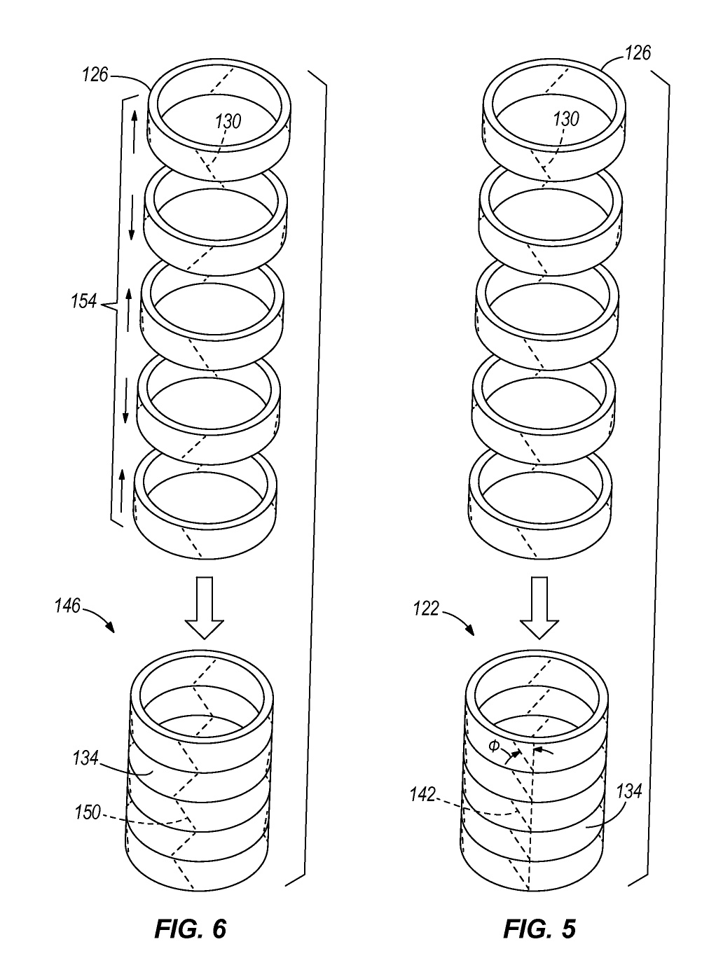

FIG. 4 is a cross section of the stator 18 shown in FIG. 2. In the illustrated construction, the stator 18 includes five ferromagnetic rings 94 arranged in an axial stack 98 to form the permanent-magnet assembly 54. Each ferromagnetic ring 94 within the stack 98 has substantially the same circumferential orientation such that the poles 58 of each ferromagnetic ring are aligned with the poles 58 of the other rings within the stack 98. In other words, the S poles of each ring magnet are substantially aligned with the S poles of the other ring magnets within the stack. Similarly, the N poles of each ring magnet are substantially aligned with the N poles of the other magnets within the stack. In the construction of FIGS. 1, 2 and 4, the flux ring 46 and each of the ferromagnetic rings 94 includes an alignment notch 106. The alignment notch 106 is provided to assist in aligning the poles 58 of each ferromagnetic ring during assembly.

As illustrated in FIG. 4, linear boundaries 110 between magnetic poles 58 within each ferromagnetic ring 94 are skewed relative to reference lines 78, to define the skew angle Φ. In the illustrated construction, the skew angle Φ at each linear boundary 110 within a ferromagnetic ring 94 is the same. Similarly, the skew angles within each subsequent ring of the stack 98 are the same, forming the illustrated “saw-tooth” 118 profile of magnetization. The skew angle Φ will typically be in the range from approximately 15 degrees to approximately 75 degrees; preferably from approximately 30 degrees to approximately 60 degrees, and even more preferably from approximately 40 degrees to approximately 50 degrees. As discussed in greater detail below, other constructions may arrange the ring magnets in alternating axial orientations, to form a “zig-zag” magnetization pattern. In still further constructions, alternative skew patterns may be formed using combinations of rings with different skew angles, or with non-linear pole boundaries.

FIG. 5 illustrates one method of constructing a permanent magnet assembly 122 for use in a stator or rotor. A plurality of ferromagnetic rings 126 (rare earth, iron, etc.) are formed using conventional manufacturing techniques. As shown in the upper half of FIG. 5, each of the ferromagnetic rings 126 is substantially identical in all dimensions, though in other constructions the rings may have various axial heights or wall thicknesses.

Each of the ferromagnetic rings 126 is then magnetized in a magnetization fixture. Because the skew angle Φ at each pole boundary 130 is linear, a conventional magnetization fixture may be used. After magnetization, the individual ferromagnetic rings are assembled into a stack 134 shown in the lower half of FIG. 5, to form a complete permanent magnet assembly 122. The combination of pole boundaries 130 forms the illustrated saw-tooth magnetization pattern 142.

FIG. 6 illustrates an alternative construction of a permanent magnet assembly 146 using stacked ring magnet aggregate magnetization. A “zig-zag” magnetization pattern 150 is created by alternating the direction of skew with every ring magnet. In other words, the individual ferromagnetic rings 126 within the stack 134 are identical to those shown in FIG. 5, but the axial orientation 154 of every other ring is reversed to create the illustrated zig-zag pattern 150.

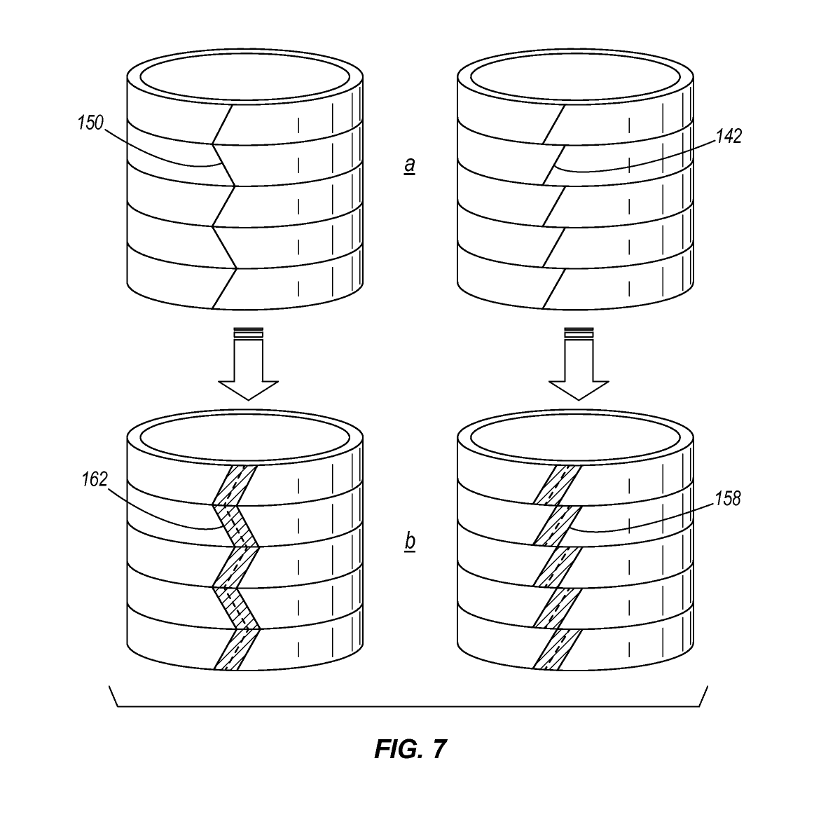

FIG. 7 is a comparison of (a) the design saw-tooth 142 and zig-zag 150 magnetization patterns versus (b) the actual magnetization patterns 158, 162. In both cases, the magnetization patterns 158, 162 are sharper and closer in geometry to the design magnetization than that illustrated in FIG. 3. Because each of the rings is magnetized individually, the resulting magnetization pattern after assembly is sharper and better defined.

While the invention has been described in the context of a stator for a DC motor, the invention has uses in other electrodynamic machinery. For instance, a ring magnet magnetized with an aggregate magnetization skew could be used in the rotor of a DC motor or generator.

Furthermore, while the embodiments of FIGS. 3-7 have each been described as having ferromagnetic rings, it should be appreciated that each of the previous embodiments may alternatively be constructed with ferrimagnetic rings. A ferrimagnetic material is one in which the magnetic moments of atoms on different sublattices are opposed, yet unequal, such that a spontaneous magnetization remains.

Thus, the invention provides, among other things, a ring-magnet assembly for use in electro-dynamic machinery. Various features and advantages of the invention are set forth in the following claims.

What is claimed is:

1. A permanent magnet assembly for use in an electro-dynamic machine, the permanent magnet assembly comprising:
a plurality of ferromagnetic ring members arranged about a longitudinal axis in a co-axial stack, each ring member having an axial orientation and configured with:
a plurality of arcuate magnetic poles arranged around a circumference of the ring member with pole boundaries between adjacent magnetic poles skewed at an angle Φ, where Φ is non-parallel to the longitudinal axis.

2. The permanent magnet assembly of claim 1, wherein consecutive ferromagnetic ring members within the stack have the same axial orientation, such that an axial sequence of pole boundaries forms a sawtooth pattern.

3. The permanent magnet assembly of claim 1, wherein consecutive ferromagnetic ring members within the stack have alternating axial orientations, such that an axial sequence of pole boundaries forms a zigzag pattern.

4. The permanent magnet assembly of claim 1, further comprising a metallic flux ring disposed about an outer radial surface of the co-axial stack.

5. The permanent magnet assembly of claim 1, wherein each ferromagnetic ring member includes a reference notch for circumferential orientation relative to other ferromagnetic ring members.

6. The permanent magnet assembly of claim 1, wherein each pole boundary is substantially linear.

7. A method of manufacturing a permanent-magnet portion of an electro-dynamic machine, the method comprising:
manufacturing a plurality of ferromagnetic ring members, each ring member having a central axis, a radius and an axial height;
magnetizing each ferromagnetic ring member to have a plurality of arcuate magnetic poles arranged around a circumference of the ring member, the arcuate magnetic poles within each ring member contacting one another at axially-skewed boundaries; and
arranging the ferromagnetic rings in a co-axial stack.

8. The method of claim 7, further comprising orientating each ferromagnetic ring member such that the magnetic poles of each ring member are axially aligned relative to the respective magnetic poles of other ring members.

9. The method of claim 7, further comprising reversing an axial orientation of alternating ferromagnetic ring members in the co-axial stack to form an aggregate zig-zag pattern of pole boundaries.

10. The method of claim 7, further comprising determining a property of a commutator and brush combination of the electro-dynamic machine and calculating an optimal magnetic skew angle for at least one of the ferromagnetic ring members based upon the property.

11. The method of claim 7, further comprising incorporating the co-axial stack into the stator of a motor.

12. The method of claim 11, wherein the motor is a brushed-DC motor.

13. The method of claim 7, further comprising incorporating the co-axial stack into the rotor of a motor.

14. An electric motor comprising:
a shaft rotatable about an axis;
a rotor coupled to the shaft for rotation about the axis; and
a stator disposed concentrically about the rotor to provide a magnetic field, the stator comprising,
a first ferromagnetic ring having at least a first magnetic pole and a second magnetic pole adjacent the first magnetic pole, a boundary between the first magnetic pole and the second magnetic pole defining a first skew angle; and
a second ferromagnetic ring having at least a third magnetic pole and a fourth magnetic pole adjacent the third magnetic pole, a boundary between the third magnetic pole and the fourth magnetic pole defining a second skew angle, the second ferromagnetic ring stacked axially upon the first ferromagnetic ring.

15. The electric motor of claim 14, wherein the first skew angle and the second skew angle are defined relative to a reference line drawn parallel to the axis.

16. The electric motor of claim 15, wherein the first skew angle and the second skew angle are substantially equal.

17. The electric motor of claim 15, wherein the first skew angle and the second skew angle are substantially opposed relative to the reference line.

18. The electric motor of claim 15, wherein the first magnetic pole is substantially axially aligned with the third magnetic pole and the second magnetic pole is substantially axially aligned with the fourth magnetic pole.

19. The electric motor of claim 18, further comprising a commutator coupled to the rotor, wherein the first skew angle and the second skew angle are optimized based upon a commutator characteristic.

20. A permanent magnet assembly for use in an electro-dynamic machine, the permanent magnet assembly comprising:
a plurality of ferrimagnetic ring members arranged about a longitudinal axis in a co-axial stack, each ring member having an axial orientation and configured with:
a plurality of arcuate magnetic poles arranged around a circumference of the ring member with pole boundaries between adjacent magnetic poles skewed at an angle Φ, where Φ is non-parallel to the longitudinal axis.
